(19) United States
(12) Patent Application Publication
(10) Pub. No.: US 2006/0238479 A1
(43) Pub. Date: Oct. 26, 2006

(54) Display device

(76) Inventors: Uki Tsuchiyama, Mobara (JP); Yoshinori Aoki, Mobara (JP); Mitsuru Goto, Chiba (JP); Kenichi Akiyama, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/401,841

(22) Filed: Apr. 12, 2006

(30) Foreign Application Priority Data
Apr. 20, 2005 (JP) 2005-122346

(51) Int. Cl. G09G 3/36

(52) U.S. Cl. 345/98

(57) ABSTRACT

The present invention, in a display device which includes a SRAM, prevents a phenomenon that power source fluctuation and display timings are not synchronized and hence, flickering occurs on a display surface of a liquid crystal panel. A display device includes a display panel having a plurality of pixels and scanning lines which apply a scanning voltage to the plurality of pixels; and a drive circuit which supplies a scanning voltage to the scanning lines, wherein the drive circuit includes a first booster circuit which generates a first voltage by elevating a reference voltage, a regulator which regulates the first voltage, and a second booster circuit which generates a second voltage by elevating a voltage outputted from the regulator. The second booster circuit generates the second voltage (selective scanning voltage) and a third voltage (non-selective scanning voltage). When video data is inputted from the outside based on an RGB interface, the second booster circuit is operated in response to an external clock.

### BACKGROUND OF THE INVENTION

1. Field of the Invention

The present invention relates to a display device, and more particularly to a technique which is effectively applicable to a drive circuit of a liquid crystal display device used in a mobile phone or the like.

2. Description of the Related Art

A TFT (Thin Film Transistor) type liquid crystal display module which includes a miniaturized liquid crystal panel in which the number of sub pixels is approximately 240×320×3 in color display has been popularly used as a display part of a portable equipment such as a mobile phone.

With respect to a liquid crystal display module which is used as a display part of a mobile phone or the like, there has been known a liquid crystal display module which includes a semiconductor memory (Static Random Access Memory; hereinafter referred to as SRAM) for reducing the power consumption. (see following patent document 1, patent document 2)

Here, following documents are known as prior art documents relevant to the present invention.

[Patent Document 1]

Japanese Patent Laid-open 2004-61892

[Patent Document 2]

Japanese Patent Laid-open 2003-408359

### SUMMARY OF THE INVENTION

In a liquid crystal display module which incorporates a SRAM therein as a frame memory, data corresponding to 1 display line is collectively read from the SRAM for every 1 H and is transferred to a latch circuit.

Further, the liquid crystal display module includes two ports consisting of an MPU access port and a display access port and it is necessary to frequently change over two ports (changeover for writing and reading) at the time of getting access to the MPU (at the time of writing data).

In the SRAM, when the writing/reading operation is performed, it is always necessary to precharge bit lines to a power source voltage and hence, the bit-line precharge occupies most of the SRAM current consumption.

Recently, along with the increase of the resolution of the liquid crystal panel (QCIF→QVGA), the capacitance of the SRAM is also increased (QCIF→QVGA) and hence, loads applied to video lines and word lines are gradually increasing.

This increase of the loads has been considered as a factor to hamper the further reduction of the power consumption of the liquid crystal display module which includes the SRAM. Particularly, when a portable equipment which includes the liquid crystal display module is driven by a battery, this obstructs the prolongation of a use time of the portable equipment.

Further, due to the above-mentioned bit-line precharge current, a voltage drop which cannot be ignored is generated and hence, there exists a possibility that an operational margin is narrowed.

Further, the liquid crystal display module which is used in the mobile phone or the like incorporates a booster circuit therein, wherein the booster circuit generates a driving voltage for driving the liquid crystal panel. In this case, the respective voltages outputted by the booster circuit are fluctuated depending on cycles of operation clocks of the booster circuit.

Then, in operating the display timing signal in synchronism with an external input signal inputted from the outside, when the booster circuit is operated in response to a clock from an oscillating circuit which is incorporated in the liquid crystal display module, the power source fluctuation and the display timing are not synchronized and hence, there may arise a case that flickers are generated on a display screen of the liquid crystal display module.

The present invention has been made to overcome the above-mentioned drawbacks of the related art and it is an object of the present invention to provide a technique which can prevent the deterioration of an operational margin attributed to a bit-line precharge current while realizing the further reduction of the power consumption in a display device which includes a SRAM.

Further, it is another object of the present invention to provide, in a device having a SRAM, a technique which can prevent the occurrence of a phenomenon that the power source fluctuation and the display timing are not synchronized and hence, flickers are generated on a display screen of the liquid crystal panel.

The above-mentioned and other objects and novel features of the present invention will become apparent from the description of this specification and attached drawings.

To briefly explain the summary of typical inventions among inventions disclosed in this specification, they are as follows.

To achieve the above-mentioned object, the present invention is directed to a display device which includes a display panel having a plurality of pixels and scanning lines which apply a scanning voltage to the plurality of pixels, and a drive circuit which supplies a scanning voltage to the scanning lines, wherein the drive circuit includes a first booster circuit which generates a first voltage by elevating a reference voltage, a regulator which regulates the first voltage, and a second booster circuit which generates a second voltage by elevating a voltage outputted from the regulator.

Here, the second booster circuit generates a selective voltage which is applied to the plurality of pixels via the scanning lines and a non-selective scanning voltage which is applied to the plurality of pixels by way of the scanning lines.

Further, according to the present invention, the display device includes a clock generating circuit which generates an inner clock, the first booster circuit is operated in response to the inner clock, and the second booster circuit is operated in response to the inner clock or an external clock which synchronizes with a control signal inputted from the outside.

For example, when video data is inputted from the outside based on a RGB interface, the second booster circuit is operated in response to the external clock.

Further, the present invention is directed to a display device which includes a drive circuit to which video data is supplied from the outside, video lines to which a video signal which the drive circuit outputs is supplied, and pixels to which the video signal is supplied via the video lines, wherein the drive circuit includes a SRAM which stores the video data and a memory control means, the SRAM is divided into a plurality of mats, and the memory control means makes precharge start timings to bit lines for respective mats different from each other at the time of reading the video data from the SRAM.

Further, the memory control means makes precharge start timings to the bit lines for respective mats of each group different from each other at the time of writing the video data to the SRAM.

Further, the memory control means performs precharging with respect to the bit lines of the mats which include memory cells to which the video data is written and does not perform the precharging with respect to the bit lines of the mats except for the mats which include memory cells to which the video data is written at the time of writing the video data to the SRAM.

Still further, the memory control means determines that, when the display device assumes a partial display state, cells which store data of 1 bit among display data of n bits are valid and cells which store data of other (n−1) bits are invalid.

To briefly explain advantageous effects obtained by the typical inventions among the inventions disclosed in this specification, they are as follows.

According to the present invention, in the display device which includes the SRAM, it is possible to realize the further reduction of power consumption and, at the same time, it is possible to prevent the degradation of an operational margin attributed to a bit-line precharge current.

According to the present invention, in the display device which includes the SRAM, the power source fluctuation and the display timing are not synchronized and hence, it is possible to prevent the occurrence of flickers on a display screen of the liquid crystal panel.

### BRIEF DESCRIPTION OF DRAWINGS

FIG. 1 is a block diagram showing the schematic constitution of a liquid crystal display module which constitutes a premise of the present invention;

FIG. 2 is a circuit diagram which shows 1 memory cell of a SRAM in the inside of a RAM shown in FIG. 1;

FIG. 3 is a block diagram showing the schematic constitution of one example of a controller circuit, a source driver and the SRAM shown in FIG. 1;

FIG. 4 shows a drive voltage necessary for driving in a thin-film-transistor-type liquid crystal display module;

FIG. 5 is a block diagram for explaining the circuit constitution of a conventional power source circuit;

FIG. 6 is a block diagram for explaining the circuit constitution of a power source circuit of an embodiment 1 of the present invention;

FIG. 7 is a circuit diagram showing one example of a regulator shown in FIG. 6;

FIG. 8 is a view showing one example of the memory arrangement of a memory circuit of an embodiment 2 of the present invention;

FIG. 9 is a view showing the constitution of the memory corresponding to 1 sub pixel shown in FIG. 8;

FIG. 10 shows a timing chart of respective control signals at the time of reading in the memory arrangement shown in FIG. 8;

FIG. 11 is a view for explaining a writing operation in the memory arrangement shown in FIG. 8;

FIG. 12 is a view which schematically shows an image which is displayed on a liquid crystal panel (PNL) in a partial display state;

FIG. 13 is a view showing a precharge circuit of a SRAM of an embodiment 2 of the present invention; and

FIG. 14 is a view for explaining a writing operation of the SRAM shown in FIG. 14.

### DETAILED DESCRIPTION OF THE INVENTION

Hereinafter, embodiments of the present invention are explained in detail in conjunction with drawings.

Here, in all drawings for explaining the embodiments, parts having identical functions are given same symbols and their repeated explanation is omitted.

### Embodiment

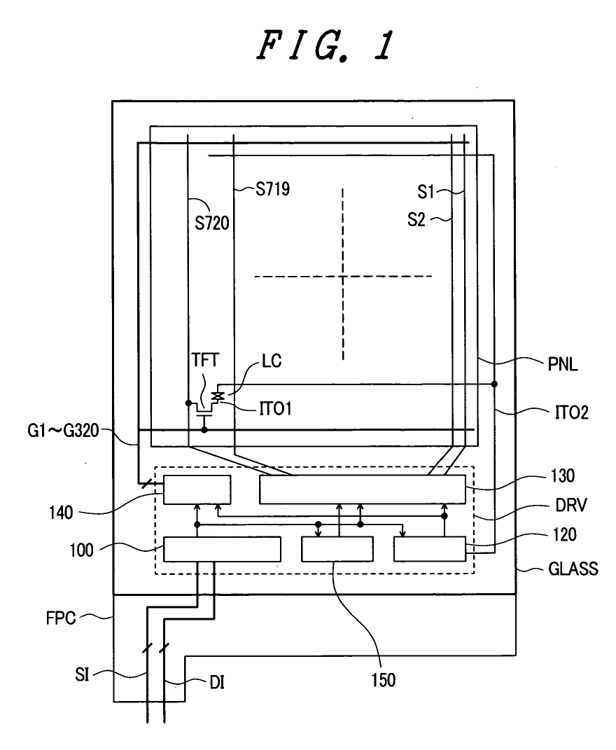

FIG. 1 is a block diagram showing the schematic constitution of a liquid crystal display module of an embodiment of the present invention.

On the liquid crystal panel (PNL), a plurality of scanning lines (or gate lines) (G1 to G320) and a plurality of video lines (or drain lines) (S1 to S720) are respectively arranged in parallel to each other.

Pixel portions are formed corresponding to portions where the scanning lines (G) and the video lines (S) intersect each other. A plurality of pixel portions are arranged in a matrix array, wherein each pixel portion includes a pixel electrode (ITO1) and a thin film transistor (TFT). In FIG. 1, the number of sub pixels of the liquid crystal panel (PNL) is 240×320×3.

A common electrode (also referred to as counter electrode) (ITO2) is provided in a state that a common electrode (ITO2) faces the respective pixel electrodes (IT01) in an opposed manner with liquid crystal sandwiched therebetween. Accordingly, a liquid crystal capacitance (LC) is formed between each pixel electrode (IT01) and the common electrode (IT02).

A liquid crystal panel (PNL) is constituted such that a glass substrate (GLASS) on which the pixel electrodes (IT01), the thin film transistors (TFT) and the like are formed and a glass substrate on which color filters and the like are formed (not shown in the drawings) are overlapped to each other with a predetermined gap therebetween, both substrates are laminated to each other using a sealing material which is formed in a frame shape in the vicinity of a peripheral portion between both substrates, liquid crystal is filled and sealed into the inside of the sealing material between both substrates from a liquid crystal filling port formed in a portion of the sealing material and, further, polarizers are laminated to outer sides of both substrates.

Here, the present invention is irrelevant to the inner structure of the liquid crystal panel and hence, the detailed explanation of the inner structure of the liquid crystal panel is omitted. Further, the present invention is applicable to the liquid crystal panel having any structure.

In the liquid crystal display module shown in FIG. 1, on the glass substrate (GLASS), a drive circuit (DRV) is mounted.

The drive circuit (DRV) includes a controller circuit 100, a source driver 130 which drives the video lines (S) of the liquid crystal panel (PNL), a gate driver 140 which drives the scanning lines (G) of the liquid crystal panel (PNL), a liquid crystal driving power source generating circuit 120 which generates a power source voltage necessary for displaying an image on the liquid crystal panel (PNL) (for example, the common voltage (Vcom) which is supplied to the common electrode (ITO2) of the liquid crystal panel (PNL)), and a memory circuit (also referred to as RAM hereinafter) 150. Further, in FIG. 1, symbol FPC indicates a flexible wiring board.

Here, in FIG. 1, a case in which the drive circuit (DRV) is constituted of one semiconductor chip is illustrated. However, the drive circuit (DRV) may be directly formed on the glass substrate (GLASS) using a thin film transistor which uses low-temperature poly-silicon as a material of a semiconductor layer.

In the same manner, a circuit which constitutes a portion of the drive circuit (DRV) is divided thus constituting the drive circuit (DRV) using a plurality of semiconductor chips or a circuit which constitutes a portion of the drive circuit (DRV) may be, for example, directly formed on the glass substrate (GLASS) using a thin film transistor which uses low-temperature poly-silicon as a semiconductor layer thereof.

Further, the drive circuit (DRV) or a circuit which constitutes a portion of the drive circuit (DRV) may be formed on a flexible wiring board in place of mounting the drive circuit (DRV) or the like on the glass substrate (GLASS).

To the controller circuit 100, display data and display control signals which are inputted from an apparatus-side micro controller unit (hereinafter referred to as MCU) or a graphic controller.

In FIG. 1, symbol SI indicates a system interface and constitutes a system to which various control signals and image data are inputted from a MCU or the like.

Symbol DI indicates a display data interface (RGB interface) and constitutes a system (external data) to which image data formed by an external graphic controller and clocks for fetching data are continuously inputted.

In the display data interface (DI), image data is sequentially fetched in response to the fetching clocks in the same manner as a drain driver used in a conventional personal computer.

The controller circuit 100 transmits the image data received from the system interface (SI) and the display data interface (DI) to a source driver 130 and a RAM 150 and controls a display.

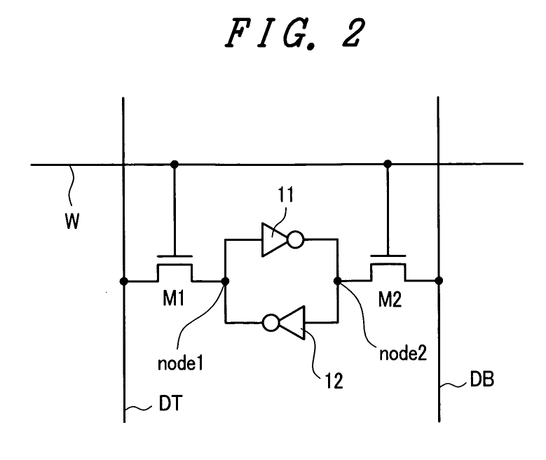

FIG. 2 is a circuit diagram showing 1 memory cell of a SRAM arranged inside the RAM 150 shown in FIG. 1.

As shown in the drawing, 1 memory cell of the SRAM is constituted of a word line (W), bit lines (DT, DB), and N-type MOS transistors (simply referred to as NMOS hereinafter) (M1, M2) which constitute transfer switching elements, and inverters (I1, I2). Here, in FIG. 2, symbols node 1 and node 2 indicate inner nodes.

Further, sizes of the respective NMOS (M1, M2) are adjusted such that when level values of the bit line DT and the inner node (node 1) as well as the bit line DB and the inner node (node 2) which are connected by MOS (M1, M2) are different from each other, a High-level (hereinafter, referred to as H-level) side node is surely changed to the Low-level (hereinafter, referred to as L-level).

That is, the reading/writing is possible only at the L-level and hence, the operation of the SRAM cell shown in FIG. 2 is expressed as follows.

(1) Writing Operation

Before setting the word line (W) at the H-level, the bit lines (DT, DB) are precharged temporarily to a power source voltage Vcc.

Next, the word line (W) is set at the H-level so as to turn on the NMOS (M1, M2). At this point of time, since both of bit lines (DT, DB) assume the H-level, a value of the inner node is not changed and the data of the RAM is held.

Next, only the bit line of the SRAM to which writing is performed is changed. For example, in writing “0”, when the bit line (DT) is set at the L-level, the inner node (node 1) always assumes the L-level and hence, “0” is written.

On the other hand, in writing “1”, after precharging is completed, only the bit line (DB) is set at the L-level. Then, the inner node (node 2) always assumes the L-level and hence, the inner node (node 1) assumes the H-level due to the inverter (I2). Accordingly, “1” is written in the SRAM.

(2) Reading Operation

Before setting the word line (W) at the H-level, the bit lines (DT, DB) are precharged temporarily to a power source voltage Vcc.

Next, the word line (W) is set at the H-level so as to turn on the NMOS (M1, M2). When the data stored in the memory cell is “0”, the inner node (node 1) assumes the L-level and hence, only the bit line (DT) is changed to the L-level.

On the other hand, when the data stored in the memory cell is “1”, the inner node (node 2) assumes the L-level and hence, only the bit line (DB) is changed to the L-level. Accordingly, the reading operation of the data of the SRAM is performed.

It is needless to say that transistor sizes in the inside of respective inverters may be adjusted to realize the above-mentioned operations.

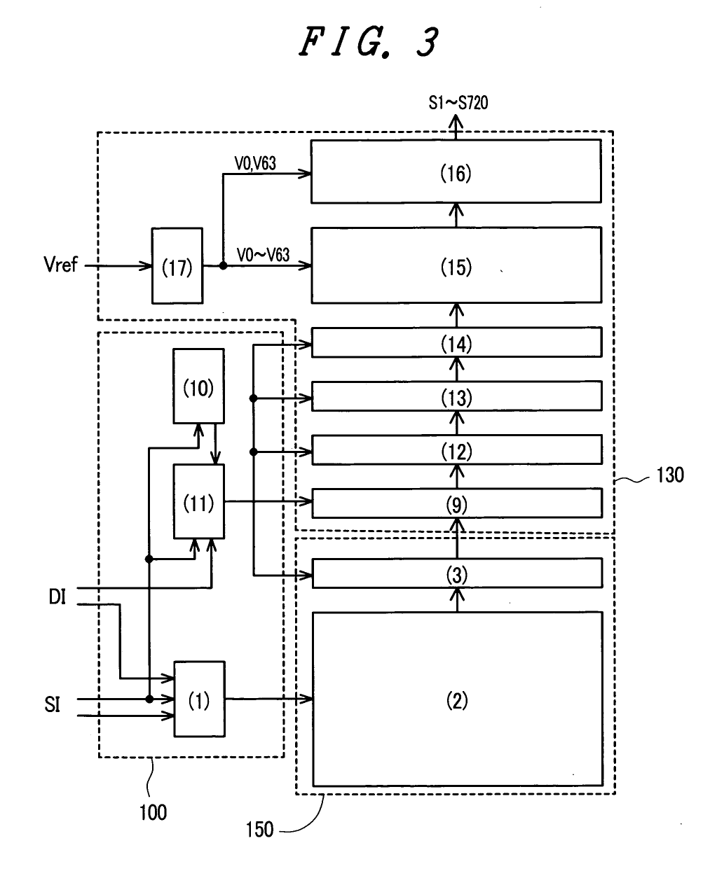

FIG. 3 is a block diagram showing the schematic constitution of one example of the controller circuit 100, the source driver 130 and the RAM 150 shown in FIG. 1.

In the constitution shown in FIG. 3, the controller circuit 100 is constituted of a SRAM controller circuit 1, and an oscillator 10 and a display timing generating circuit 11.

Further, the source driver 130 is constituted of an arithmetic circuit 9, a display data latch circuit (1) 12, a display data latch circuit (2) 13, a level shift circuit 14, a DA converting circuit (a gray scale voltage decoding circuit) 15, an output circuit (a current amplifying amplifier) 16, and a gray scale voltage generating circuit 17

Further, the RAM 150 is constituted of a SRAM 2 and a SRAM data latch circuit 3.

In the constitution shown in FIG. 3, image data from the SI (system interface) or image data from the DI (RGB interface) is inputted to the SRAM control circuit 1 and is transmitted to the SRAM 2.

The data which is stored in the SRAM 2 (SRAM data) is latched by the SRAM data larch circuit 3 and, thereafter, is used for displaying an image on a liquid crystal panel (PNL).

The data transmitted to the SRAM 2 can be stored by an amount corresponding to the RAM capacitance and can be used as a frame memory of a still picture or a motion picture.

The RAM capacitance is changed depending on the number of pixels and the number of display colors of the liquid crystal panel (PNL). The RAM capacitance may have the data corresponding to the whole number of pixels or whole gray scales or may have the data which exceeds the number of pixels of the liquid crystal panel (PNL) when a clock display of a mobile phone is overlapped to the display image. To the contrary, the RAM capacitance may only have information on only a standby screen of the mobile phone (only clock display or the like).

For example, these cases may include, in QVGA, a case in which the mobile phone does not have the RAM capacitance corresponding to the whole 320 lines and has the data corresponding to only 92 lines or a case in which the display color is limited to 8 colors (one bit for each RGB). Here, the RAM capacitance possesses only the image information of the standby screen for reducing the power consumption.

With the use of the SRAM 2, it is possible to allow the liquid crystal panel (PNL) to display a still image without driving an external bus. Here, a state in which the number of display lines is limited or the number of display colors is limited in a standby state is referred to as partial display.

The video data which is latched by the SRAM data latch circuit 3 is held as data for 1 scanning line in the display data latch circuit (1) 12 and the display data latch circuit (2) 13 via the arithmetic circuit 9.

Here, the display data latch circuit (2) 13 may not be always necessary depending on the timing of a signal inputted from DI (RGB interface).

The SRAM data latch circuit 3, the arithmetic circuit 9, the display data latch circuit (1) 12, the display data latch circuit (2) 13 are operated in response to a display timing clock (CL 1) which is generated by the display timing generating circuit 11.

When there is no synchronizing signal (dot clock) which is inputted from the DI (RGB interface), it is necessary to generate a timing clock for synchronizing by the inner oscillator 10. The system which uses only the SI (system interface) or the partial display for realizing the low power consumption display corresponds to such a case.

That is, the display timing clock (CL 1) is generated by the synchronizing clock (DOTCLK) which is contained in the DI (RGB interface) when the DI (RGB interface) is used, while the clock which is generated by the oscillator 10 is used when the DI (RGB interface) is not used.

The video data which is latched by the display data latch circuit (2) 13 is, after a voltage level thereof is converted by the level shift circuit 14, converted to a gray scale voltage to an analog gray scale voltage by the DA converting circuit (gray scale voltage decoding circuit) 15.

The gray scale voltage has a current thereof amplified by the output circuit (current amplifying amplifier) 16 and is outputted to the respective video lines (S1 to S720).

Here, gray scale voltages of 64 gray scales (V0 to V63) which are generated by the gray scale voltage generating circuit 17 are inputted to the DA converting circuit (gray scale voltage decoding circuit) 15.

### Embodiment 1

In a miniaturized portable equipment such as a mobile phone, a battery is generally used as a power source. Further, in view of a distribution amount of the battery, a type of battery whose output voltage is approximately 1.5V to 4V is popularly used. Accordingly, the power source voltage for liquid crystal display device is produced by using a conventionally well-known charge-pomp-type booster circuit.

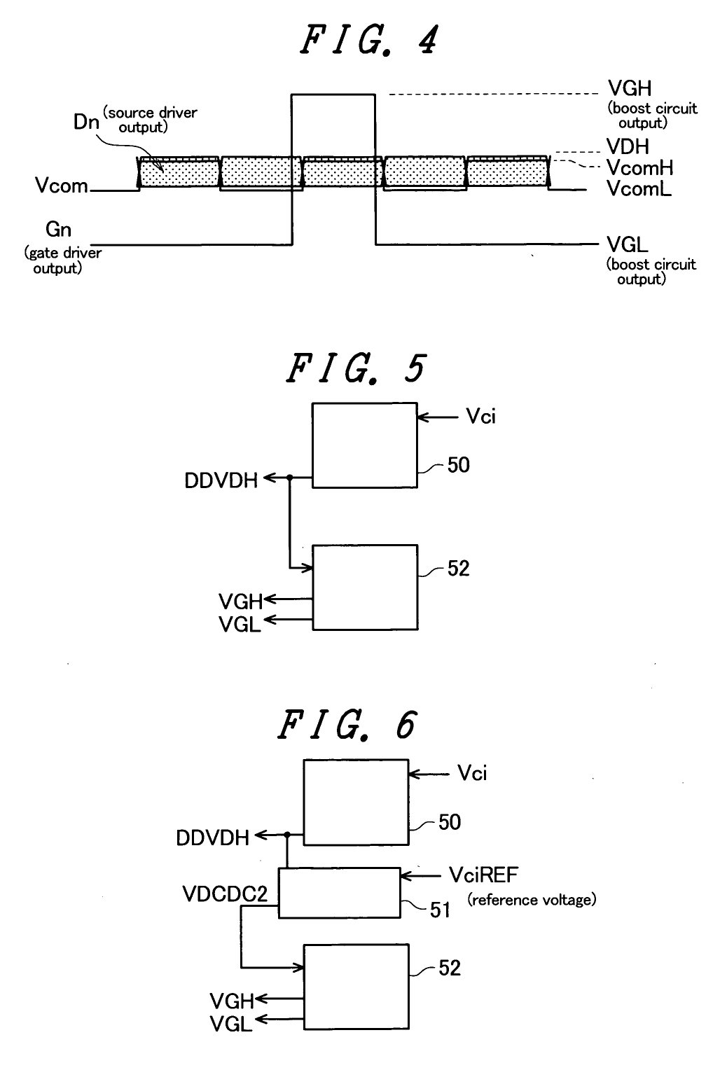

FIG. 4 shows drive voltages necessary for driving in the thin-film-transistor-type liquid crystal display module. Here, FIG. 4 shows respective driving voltages when a so-called common voltage inversion driving method which inverts voltages applied to the pixel electrode (ITO1) and the common electrode (ITO2) at a fixed cycle is used.

In FIG. 4, symbol VGH indicates a voltage for turning on the thin film transistor (TFT) in a pixel portion (so-called selective scanning voltage) and approximately 9.0V to 16.5V becomes necessary at (VGH-GND). Further, VGL indicates a voltage for turning off the thin film transistor (TFT) in a pixel portion (so-called non-selective scanning voltage) and approximately −4.0V to −5.5V becomes necessary at (VGL-GND)

Symbol VDH indicates a gray scale reference voltage and the gray scale voltages are provided by the source driver 130 based on the gray scale reference voltage VDH. It is necessary to set (VDH-GND) to approximately 4.0 to 5.0V in view of the propertyes of the liquid crystal material.

Symbol VcomH indicates a High-level (hereinafter referred to as H-level) side voltage which is applied to the common voltage (ITO2), and Symbol VcomL indicates a Low-level (hereinafter referred to as L-level) side voltage which is applied to the common voltage (ITO2).

FIG. 5 is a block diagram for explaining the circuit constitution of a conventional power source circuit.

The power source circuit shown in FIG. 5 indicates a portion which generates voltages VDH and VGL in the liquid crystal driving power source generating circuit 120 shown in FIG. 1.

The booster circuit 1 (50) which is shown in FIG. 5 generates a voltage DDVDH based on the reference voltage Vci. The voltage DDVDH is a voltage for generating the voltage VDH, the voltage VcomH and the voltage VcomL.

A booster circuit 2 (52) shown in FIG. 5 generates voltages VGH, VGL based on the voltage DDVDH. Here, (Vci-GND) is approximately 2.5 to 3.5V, and (DDVDH-GND) is approximately 4.0 to 6.0V.

In general, the respective voltages outputted from the booster circuit are changed at a cycle of an operating clock of the booster circuit. Particularly, the voltages VGH, VGL are obtained by directly outputting the output voltage of the booster circuit from the gate driver 140.

In transferring the screen data and performing a display using the CPU interface or the like, the operating clock of the booster circuit and the display timing signal of the clock (CL 1) are synchronized with the clock which is generated by the oscillator 10 which is incorporated in the source driver 130 and hence, there is no possibility that the above-mentioned voltage fluctuation give an adverse influence toward the display.

However, when the RGB interface is used, the display timing of the clock (CL 1) or the like is operated in synchronism with an external input signal such as a vertical synchronizing signal (VSYNC), a horizontal synchronizing signal (HSYNC), a dot clock (DOTCLK) or the like, while the booster circuit is operated based on a clock generated by the oscillator 10 which is incorporated in the booster circuit and hence, the above-mentioned voltage fluctuation and the display timing are not synchronized with each other thus giving rise to a case that flickers are generated on the display screen.

This embodiment is provided for preventing the above-mentioned phenomenon that the voltage fluctuation and the display timing are not synchronized and hence, the flickers are generated on the display screen.

FIG. 6 is a block diagram for explaining the circuit constitution of the power source circuit of the embodiment 1 of the present invention.

The power source circuit shown in FIG. 6 indicates a portion which generates the voltages VDH, VGL in the liquid crystal driving power source generating circuit 120 shown in FIG. 1.

Also in the power source circuit shown in FIG. 6, the voltage DDVDH is generated based on the reference voltage Vci using the booster circuit 1 (50).

However, in the power source circuit of this embodiment, the voltage DDVDH outputted from the booster circuit 1 (50) is regulated by a regulator 51, and the booster circuit 2 (52) generates the voltages VGH, VGL based on a voltage VDCDC 2 outputted from the regulator 51.

The regulator 51 generates a voltage VDCDC 2 based on an inputted VciREF using the voltage DDVDH as the power source voltage. Here, VciREF=Vci and (VDCDC 2−GND) is approximately 4.0 to (DDVDH−0.5)V.

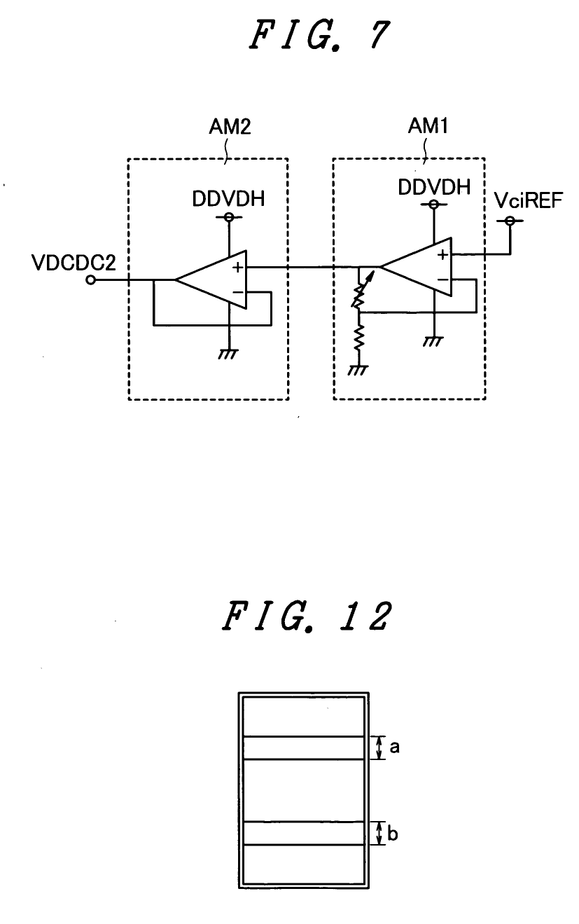

One example of the regulator 51 shown in FIG. 6 is shown in FIG. 7.

In the circuit shown in FIG. 7, the voltage VciREF is amplified by the amplifier (AM1) which uses the voltage DDVDH as the power source voltage, and the amplified voltage is outputted via voltage follower circuit (AM2) which uses the voltage DDVDH as the power source voltage.

The above-mentioned flickering is generated by the voltage fluctuation of the voltage VGH which is an ON voltage of a gate of the thin film transistor (TFT). Accordingly, in this embodiment, the voltage DDVDH which is the reference power source of the booster circuit 2 (52) is regulated.

Here, although it is desirable to regulate the voltage VGH to stabilize the voltage VGH, it is necessary to use a high dielectric-strength MOS transistor. Accordingly, in this embodiment, as described previously, a regulator 51 which regulates the voltage DDVDH which can be formed by a low dielectric-strength MOS transistor is added.

Further, in this embodiment, in case of the RGB interface, only the booster circuit 2 (52) which generates the voltage VGH is operated in response to a signal which is synchronized with the display timing signal such as the clock signal (CL 1).

However, it is necessary to operate the power source circuit 120 which is incorporated in the source driver 130 before the display is performed and hence, before the display is performed, in the same manner as the related art, the clock which is generated by the oscillator 10 which is incorporated in the source driver 130 is used, and at the time of performing the display using the RGB interface or the like, the operation clock is changed only with respect to the booster circuit 2 (52). This operation can beset from the MPU using an instruction signal.

Here, from a view point that it is sufficient to synchronize the voltage fluctuation, in place of adding the regulator 51, the operation clock of the booster circuit 1 (50) which generates the voltage DDVDH may be synchronized with the display timing signal of the clock (CL 1) or the like. However, the voltage DDVDH increases the current consumption and hence, to ensure the driving ability, the clock signal (CL 1) is insufficient in speed. Accordingly, the regulator 51 is adopted without changing the operational clock.

### Embodiment 2

This embodiment is provided for preventing the degradation of an operational margin attributed to a bit-line precharge current.

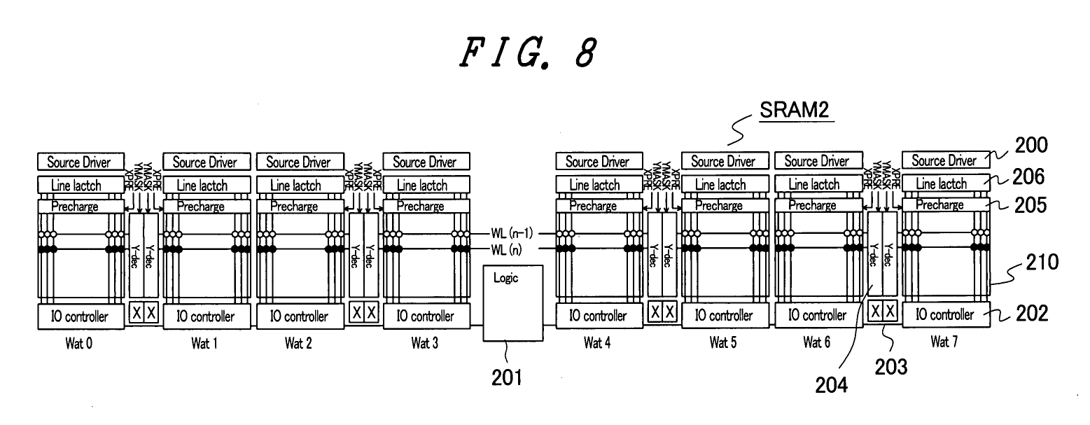

FIG. 8 is a view showing one example of the memory arrangement of a memory circuit of the embodiment 2 according to the present invention. Here, the memory circuit shown in FIG. 8 corresponds to the memory circuit 150 shown in FIG. 1.

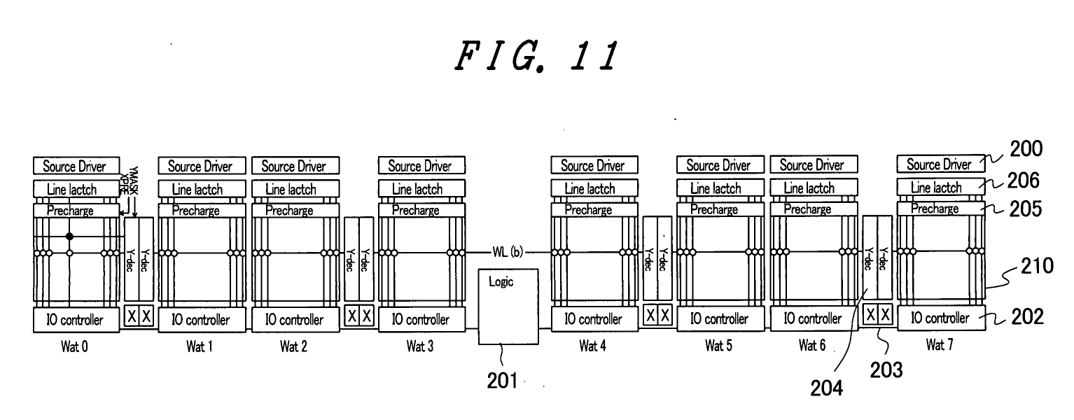

In FIG. 8 and FIG. 11 which is described later, numeral 200 indicates a source driver, numeral 201 indicates a control circuit, numeral 202 indicates an IO control circuit, numeral 203 indicates an X decoder, numeral 204 indicates a Y decoder, numeral 205 indicates a precharging circuit, numeral 206 indicates a latch circuit, and numeral 210 indicates a memory cell part. Here, the source driver 200 corresponds to the source driver 130 shown in FIG. 1, and the latch circuit 206 corresponds to the SRAM data latch circuit shown in FIG. 3.

As shown in FIG. 8, the SRAM 2 corresponds to the arrangement of the screen display, wherein bit lines (BL) which correspond to the order of video lines (S) are arranged in the lateral direction and word lines (WL) which correspond to the order of the scanning lines (G) are arranged in the longitudinal direction.

In general, the SRAM is suitably divided to decrease a driving load. In FIG. 8, the word lines (WL) is divided into 8 memory mats (MAT0 to MAT7).

FIG. 9 is a view showing the constitution of the memory corresponding to 1 sub pixel shown in FIG. 8, wherein 1 sub pixel is constituted of 6 bits. In FIG. 9, 6-bit lines (B1 to B6) correspond to 1 video line.

As described previously, in performing the writing/reading operation, it is always necessary to precharge the bit lines with the power source voltage. Then, when the reading operation is executed collectively with 8 memory mats (Mat0 to Mat7), there exist a possibility that a power source voltage drop which can not be ignored is generated by the precharge current and hence, the operational margin is degraded.

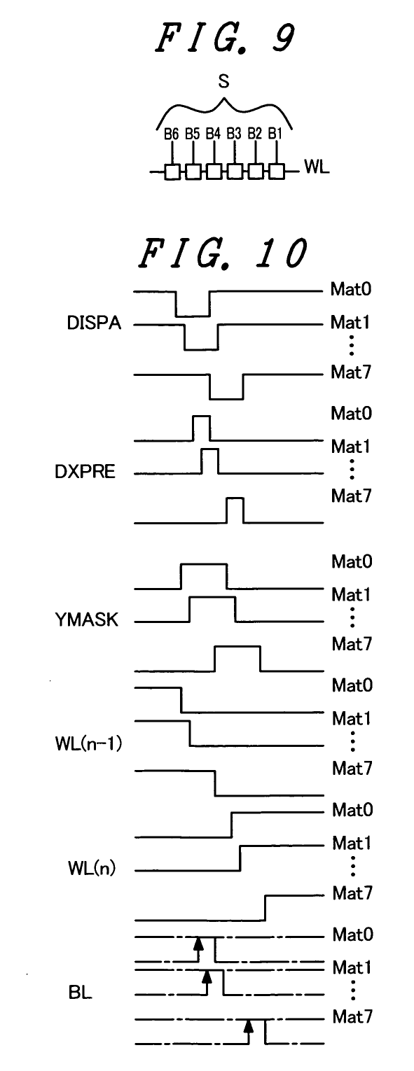

Accordingly, in this embodiment, at the time of reading SRAM, as shown in FIG. 10, timings of the precharge signals XPRE are slightly displaced for respective mats thus dispersing the precharge current at the time of precharging the bit lines whereby the peak current is decreased.

Here, in FIG. 10, symbol DISPA indicates a synchronizing signal, symbol YMASK indicates a Y address mask signal, symbol WL indicates word lines, and symbol BL indicates bit lines.

Further, in place of displacing the timings of the precharge signals XPRE slightly for respective mats, a plurality of mats may be divided into groups, for example into two groups consisting of mats, 0, 2, 4, 6 and mats 1, 3, 5, 7, and a precharge current at the time of performing the bit line precharge is dispersed for every mat of each group.

In the same manner, in this embodiment, at the time of writing the data into the SRAM, as shown in FIG. 11, the precharge operation is performed only with respect to the mat to which an X address hits (here, mat Mat0) and a previous state is held with respect to non-active mats (here, Mat1 to Mat7) which the X address does not hit, and the precharge which follows the transition to the Y address is not performed.

Accordingly, in this embodiment, in the liquid crystal display module which has the SRAM, it is possible to achieve the further reduction of power consumption and, at the same time, it is possible to prevent the degradation of the operational margin attributed to the bit line precharging.

### Embodiment 3

This embodiment is provided for reducing a bit-line precharge current in a partial display state (low power mode).

In the above-mentioned liquid crystal display module which becomes a premise of the present invention, with the use of the SRAM 2, it is possible to display the still picture on the liquid crystal panel (PNL) without driving an external bus. Here, a state in which the number of display line is limited or the number of display colors is limited as in the case of a standby state is referred to as a partial display.

The partial display is a display method which provides a display of 8 colors (=2×2×2) in total consisting of two colors for R, G, B respectively, wherein only a watch or the like is displayed and the number of scanning lines in use can be also reduced.

FIG. 12 is a view which schematically shows an image displayed on the liquid crystal panel (PNL) in the partial display state. Here, regions a, b in FIG. 12 show portions of 8 color display and other regions constitute white or black non-display regions.

For example, when the display data is 6 bits and hence, 6 bit lines BL [6n+5: 6n+0] correspond to one video line, in the partial display state, at the time of writing data into the SRAM, access only to the bit line BL [6n+5] is allowed and the access to other lines BL [6n+4: 6n+0] is not allowed and hence, it is possible to make the bit lines BL[6n+4: 6n+0] in valid (or static).

Since the current consumption of SRAM is mostly occupied by the precharge current and hence, when 5 bit lines out of 6 bit lines are set free from the precharging, it is possible to suppress a waste precharge current.

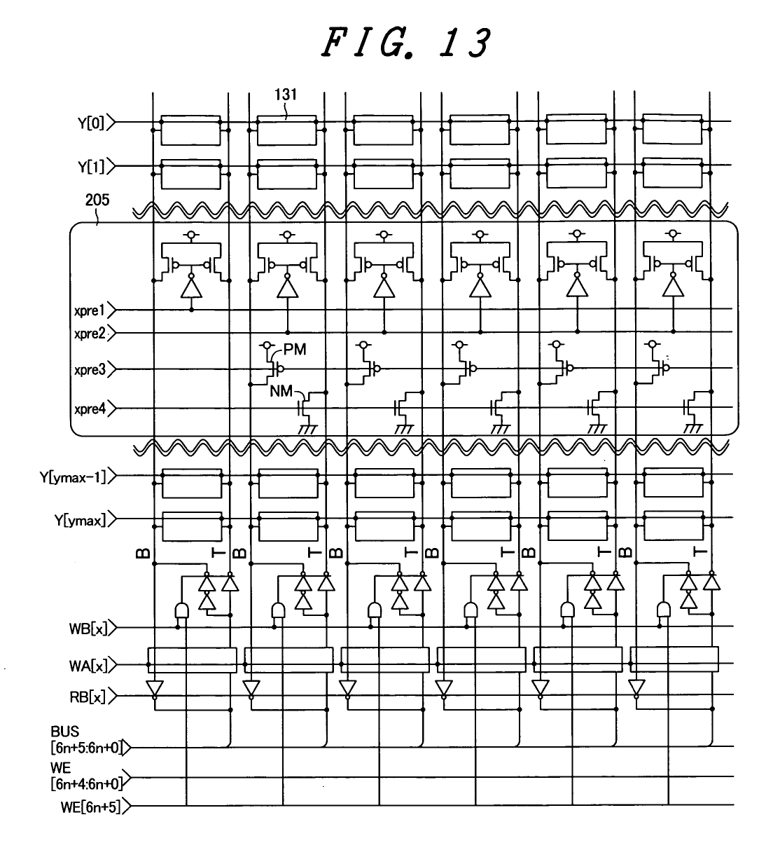

Accordingly, in this embodiment, in the partial display state, as shown in FIG. 13, in the bit lines BL [6n+4: 6n+0], a p-type MOS transistor (PM) which fixes a True side at a voltage GND and an n-type MOS transistor (NM) which fixes a Bar side at the voltage VDD are added. Here, in FIG. 13, numeral 151 indicates a memory cell and numeral 205 indicates a precharge circuit.

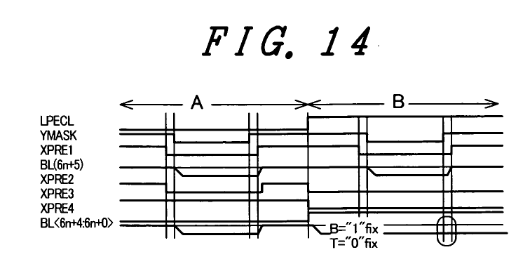

Accordingly, the control of bit lines requires individual controls respectively and hence, the precharge signals are constituted of four signals, that is, XPRE 1/2/3/4. In FIG. 14, control waveforms of the bit lines are shown. In FIG. 14, the display control is performed based on a usual RAM access mode during a period A and the 8-color-display low power mode is performed during a period B. Further, in this embodiment in the partial display state, at the time of writing the data into the SRAM, due to write enable signal (WE [6n+4: 6n+0]), the writing of the data into the bit lines BL [6n+4: 6n+0] is prohibited and, at the same time, values of BUS [6n+4: 6n+0] are fixed to “1”.

In this manner, at the time of performing 8 color mode writing which is a partial display state, only the access to the bit line BL [6n+5] is allowed and other bit lines BL [6n+4: 6n+0] are set invalid (or static) and hence, it is possible to suppress the wasteful precharge current and, at the same time, can reduce the current consumption of the SRAM.

Here, in the above-mentioned explanation, the explanation has been made with respect to the embodiments in which the present invention is applied to the TFT-type liquid crystal display module. However, the present invention is not limited to such embodiments and the present invention is applicable to an EL display device which includes organic EL elements.

Although the inventions made by inventors of the present inventions have been specifically explained based on embodiments, the present invention is not limited to the above-mentioned embodiments and various modifications can be made without departing from the gist of the present invention.

What is claimed is:

1. A display device comprising:
a display panel having a plurality of pixels and scanning lines which apply a scanning voltage to the plurality of pixels; and
a drive circuit which supplies a scanning voltage to the scanning lines, wherein
the drive circuit includes
a first booster circuit which generates a first voltage by elevating a reference voltage,
a regulator which regulates the first voltage, and
a second booster circuit which generates a second voltage by elevating a voltage outputted from the regulator.

2. A display device according to claim 1, wherein the second booster circuit generates the second voltage and a third voltage.

3. A display device according to claim 2, wherein the second voltage is a selective scanning voltage which is applied to the plurality of pixels via the scanning lines, and
the third voltage is a non-selective scanning voltage which is applied to the plurality of pixels via the scanning lines.

4. A display device according to any one of claims 1 to 3, wherein the display device includes a clock generating circuit which generates an inner clock,
the first booster circuit is operated in response to the inner clock, and
the second booster circuit is operated in response to the inner clock or an external clock which synchronizes with a control signal inputted from the outside.

5. A display device according to claim 4, wherein when video data is inputted from the outside based on a RGB interface, the second booster circuit is operated in response to the external clock.

6. A display device comprising:
a drive circuit to which video data is supplied from the outside; video lines to which a video signal which the drive circuit outputs is supplied; and
pixels to which the video signal is supplied via the video lines, wherein
the drive circuit includes
a SRAM which stores the video data and a memory control means,
the SRAM is divided into a plurality of mats, and
the memory control means makes precharge start timings to bit lines for respective mats different from each other at the time of reading the video data from the SRAM.

7. A display device comprising:
a drive circuit to which video data is supplied from the outside; video lines to which a video signal which the drive circuit outputs is supplied; and
pixels to which the video signal is supplied via the video lines, wherein
the drive circuit includes a SRAM which stores the video data and a memory control means,
the SRAM is divided into a plurality of mats,
the plurality of mats are divided into groups, and
the memory control means makes precharge start timings to bit lines for respective mats of each group different from each other at the time of reading the video data from the SRAM.

8. A display device comprising:
a drive circuit to which video data is supplied from the outside; video lines to which a video signal which the drive circuit outputs is supplied; and
pixels to which the video signal is supplied via the video lines, wherein
the drive circuit includes
a SRAM which stores the video data and a memory control means,
the SRAM is divided into a plurality of mats, and
the memory control means performs precharging with respect to the bit lines of the mats which include memory cells to which the video data is written and does not perform the precharging with respect to the bit lines of the mats except for the mats which include memory cells to which the video data is written at the time of writing the video data into the SRAM.

9. A display device comprising:
a drive circuit to which video data is supplied from the outside; video lines to which a video signal which the drive circuit outputs is supplied; and
pixels to which the video signal is supplied via the video lines, wherein
the drive circuit includes a SRAM which stores the video data and a memory control means, and
the memory control means determines that, when the display device assumes a partial display state, cells which store data of 1 bit among display data of n bits are valid and cells which store data of other (n−1) bits are invalid.

10. A display de-vice according to claim 9, wherein the SRAM includes a means 1 which applies a first reference voltage or second reference voltage to the bit lines to which the cells which are determined invalid are connected in a partial display state.

11. A display device according to claim 9 or 10, wherein the SRAM includes a means 2 which prohibits the data writing to the invalid cells in the partial display state.

12. A display device according to claim 10 or claim 11, wherein the written data to the invalid cell is data which forms the voltage of the bit lines which are connected to the invalid cells into the voltage which is applied to the means 1.
